(19) United States
(12) Patent Application Publication
(10) Pub. No.: US 2008/0085621 A1
(43) Pub. Date: Apr. 10, 2008

(54) Electrical Connector

(76) Inventors: David Wise, Dearborn, MI (US); Brent Hall, Grand Blanc, MI (US); Timothy Parkinson, Canton, MI (US)

Correspondence Address: RICHARD M. SHARKANSKY, PO BOX 557, MASHPEE, MA, 02649, US

(21) Appl. No.: 11/538,522

(22) Filed: Oct. 4, 2006

(51) Int. Cl. H01R 13/52

(52) U.S. Cl. 439/271

(57) ABSTRACT

An electrical connector having a cup-like first dielectric housing with electrical contacts retained by a base portion of the housing is disclosed. The electrical contacts are disposed in a region spaced from a sidewall portion. An adhesive filled capsule is disposed in the region. A second dielectric housing is configured for insertion into the cup-like first dielectric housing and having second electrical contacts retained by the second housing configured for mating with the first electrical contacts. The second dielectric housing has a sidewall with a frontal portion disposed in the region for engaging and rupturing the capsule when the second dielectric housing is inserted within the first dielectric housing to release adhesive from the adhesive filled capsule into the cup-like, first dielectric housing.

### TECHNICAL FIELD

This invention relates generally to electrical connectors and more particularly to electrical connectors having reduced motion between mating portions of the connectors.

### BACKGROUND

As is known in the art, electrical connectors include a pair of mating portions: one typically referred to as the female connector and the other the male connector. In some applications, such as when used in the electronic throttle body of an internal combustion engine, the relative motion between the mating connectors in the wire harness and the connector on the electronic throttle body (ETB) may result in plating at the electrical terminal/contact interface to be worn through due to vibration thus causing an increase in electrical contact resistance or loss of signal.

### SUMMARY

In accordance with the present invention, an electrical connector is provided having a cup-like first housing having electrical contacts retained therein. An adhesive filled capsule is disposed in the first housing. A second housing is configured for insertion into the cup-like first housing. The second housing includes second electrical contacts retained by the second housing configured for mating with the first electrical contacts. The second housing has a member disposed for engaging and rupturing the capsule when the second housing is inserted within the first housing to release adhesive from the adhesive filled capsule into the cup-like, first housing.

In one embodiment, an electrical connector is provided having a cup-like first dielectric housing having electrical contacts retained by a base portion, such electrical contacts being disposed in a region spaced from a sidewall portion. An adhesive filled capsule is disposed in the region. A second dielectric housing is configured for insertion into the cup-like first dielectric housing and having second electrical contacts retained by the second housing configured for mating with the first electrical contacts. The second dielectric housing has a sidewall with a frontal portion disposed in the region for engaging and rupturing the capsule when the second dielectric housing is inserted within the first dielectric housing to release adhesive from the adhesive filled capsule into the cup-like, first dielectric housing.

In one embodiment, an electrical connector is provided having a first connector member comprising: a cup-like first dielectric housing having a base portion and a sidewall portion, such sidewall portion terminating at the bottom portion; and a plurality of first electrical contacts retained by the base portion, the plurality of electrical contacts being disposed in a region spaced from the sidewall portion. The electrical connector includes a capsule disposed on the base portion in the region spaced from the sidewall portion. An adhesive is disposed within the capsule. The electrical connector includes a second connector member comprising: a second dielectric housing having a sidewall configured for insertion into the cup-like first dielectric housing, such sidewall having a frontal portion in registration with the region spaced from the sidewall portion of the first dielectric housing when the second dielectric housing is inserted within the first dielectric housing, and a plurality of second electrical contacts configured for mating with the first electrical contacts to provide electrical connection between the first electrical contacts and the second electrical contacts, such electrical contacts being retained by the second dielectric housing within the sidewall of the second dielectric housing. The frontal portion of the sidewall of the second dielectric housing engages and ruptures the capsule when the second dielectric housing is inserted within the first dielectric housing releasing the adhesive from the capsule into the cup-like, first dielectric housing.

In accordance with another feature of the invention, a method includes providing cup-like first housing having electrical contacts retained by a base portion; disposing an adhesive filled capsule in the first housing; inserting a second housing insertion into the cup-like first housing, such second electrical contacts being retained by the second housing and configured for mating with the first electrical contacts, such second housing having a member disposed for engaging and rupturing the capsule when the second housing is inserted within the first housing to release adhesive from the adhesive filled capsule into the cup-like, first housing; and engaging and rupturing the capsule with the member when the second housing is inserted within the first housing to release adhesive from the adhesive filled capsule into the cup-like, first housing.

The capsule keeps the glue fresh and prevents the glue from being exposed to air and drying. When the connector halves are joined, the capsule is punctured allowing the glue to spread evenly and dry. Typical problems avoided with the capsule application method are: old/stale glue; glue fumes and other environmental and health issues; extra equipment needed to deal with these issues such as, expensive application equipment and maintenance (machines typically must be cleaned after every shift), glue drying prematurely and potentially damaging application equipment and parts, and the mess. Typical glue application methods are messy, and manufacturing engineers just don't like to deal with them. Glue ends up on the floor, on clothes, on hands, everywhere. Additionally, the capsule method applies glue with no additional labor/processes/steps. The process of assembling the 2 connector halves (which is done anyway) also releases and applies the glue.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is an isometric view of a first housing of an electrical connector according to the invention;

FIG. 1B is a side elevation, cross-sectional view of a second housing of the connector, insertion of the second housing into the first housing providing the connector according to the invention;

FIG. 2A is a side view of the first and second housings of FIG. 1A and 1B prior to engagement;

FIG. 2B is a side view of the first and second housings of FIG. 1A and 1B partially engaged; and

FIG. 2C is a side view of the first and second housings of FIGS. 1A and 1B fully engaged.

Like reference symbols in the various drawings indicate like elements.

### DETAILED DESCRIPTION

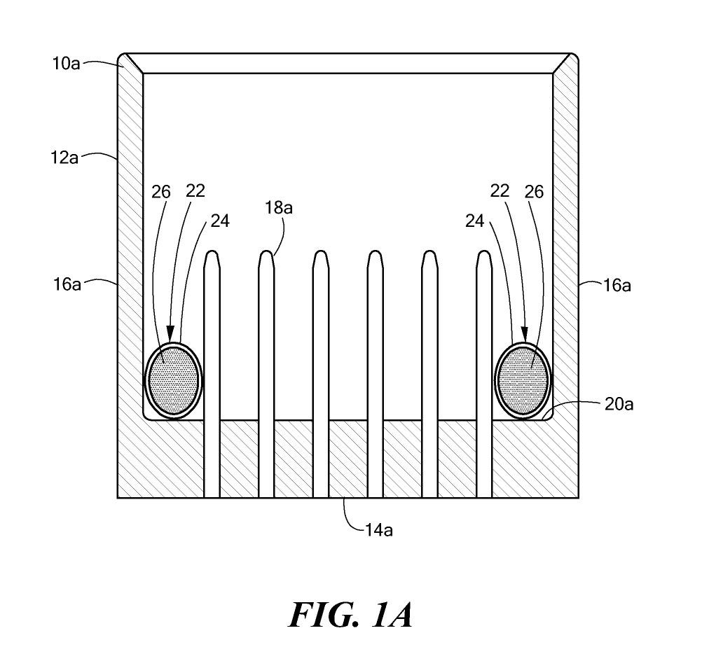

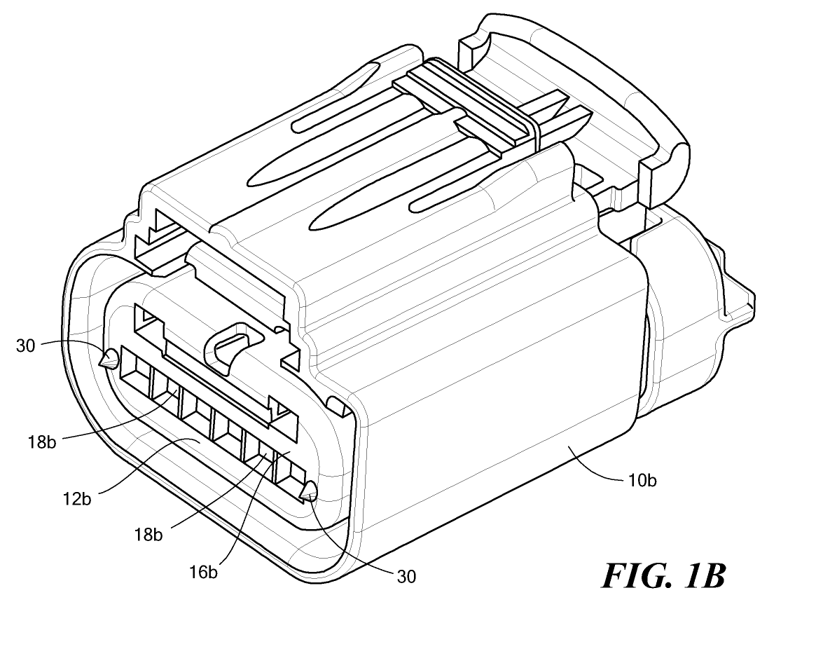

Referring now to FIGS. 1A and 1B, a pair of matable connector members 10a, 10b, respectively, for an electrical connector is shown. The first connector member 10a includes: a cup-like first dielectric housing 12a having a base portion 14a and a sidewall portion 16a, such sidewall portion 16a terminating at the bottom portion 14a, and a plurality of first electrical contacts 18a retained by the sidewall 16a and the base portion 14a. The plurality of electrical contacts 18a is disposed in a region 20a, here a pair of regions 20a, spaced from the sidewall portion 14a. A capsule 22, here a pair of capsules, is disposed on the base portion 14a in the region 20a spaced from the sidewall portion 16a. The capsule 22 has, here for example, a plastic housing 24. An adhesive 26 is disposed within the capsule 22.

The second connector member 10b includes a second dielectric housing 12b having a sidewall 16b configured for insertion into the cup-like first dielectric housing 12a. The sidewall 16b has a frontal portion 30 in registration with the regions 20a spaced from the sidewall portion 14a of the first dielectric housing 12a when the second dielectric housing 12b is inserted within the first dielectric housing 12a. The second connector member 10b also includes a plurality of second electrical contacts 18b configured for mating with the first electrical contacts 18a to provide electrical connection between the first electrical contacts and the second electrical contacts 18a, 18b. The electrical contacts 18b are retained by the second dielectric housing 12b within the sidewall 12b of the second dielectric housing. The frontal portion 30 of the sidewall 14b of the second dielectric housing 12b engages and ruptures the housing 24 of the capsule 22 when the second dielectric housing 12b is inserted within the first dielectric housing 12a releasing the adhesive 26 from the capsule 22 into the cup-like, first dielectric housing 10a.

Here, the capsules 22 are disposed on the sidewall 12a and the base portion 20a of the first dielectric member 10a. Here, the first electrical contacts 18a are pins and the second electrical contacts 18b are sleeves to receive the pins 18a.

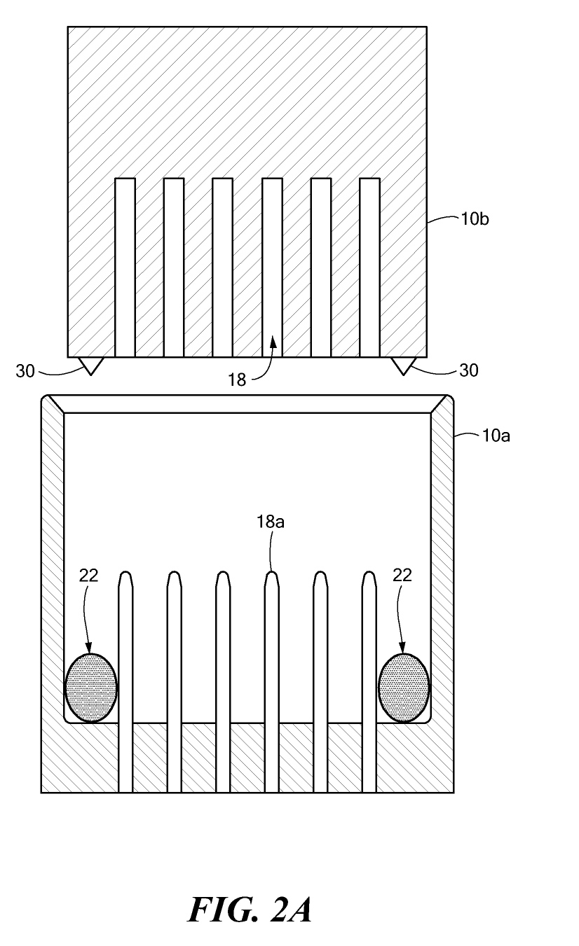

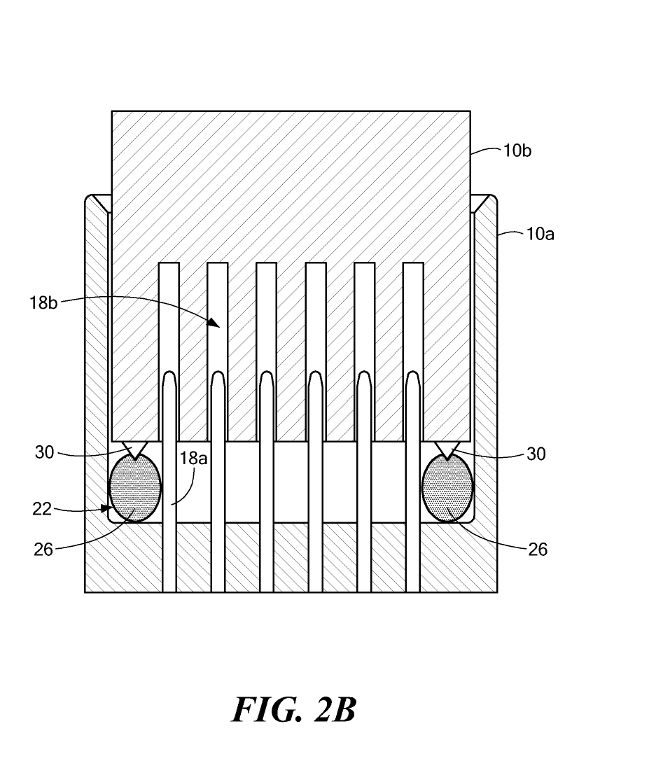

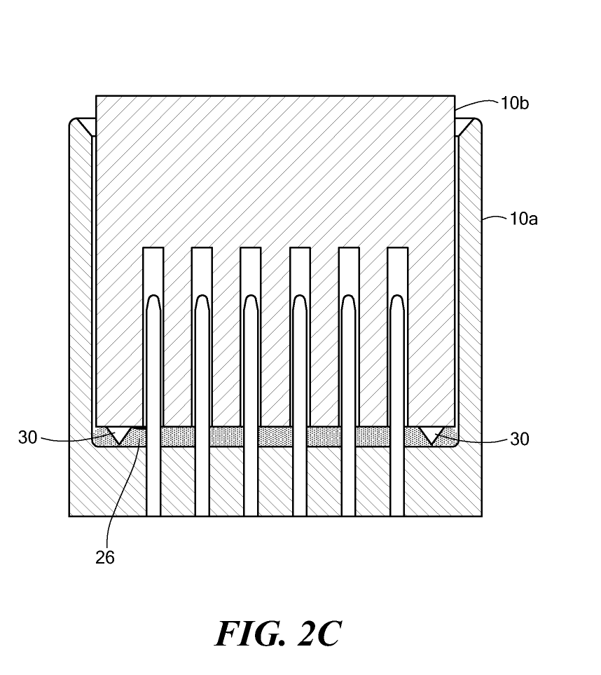

The pair of matable member 10a, 10b is attached as follows: Referring also top FIGS. 2A, 2B and 2C, the first member 10a providing the cup-like first housing 12a having electrical contacts 18a retained by the base portion 14a. Next, the adhesive filled capsule 22 is disposed within the first housing 12a. Next, the second housing 12b is inserted into the cup-like first housing 12a with the second electrical contacts 18b mating with the first electrical contacts 18a. As the members 10a, 10b are mated, the frontal portion 30 of the first housing engages and ruptures the housing 24 of the capsule 22 when the second housing 12b is inserted within the first housing 12a to thereby release the adhesive 26 from the adhesive filled capsule 22 into the cup-like, first housing 12a.

A number of embodiments of the invention have been described. Nevertheless, it will be understood that various modifications may be made without departing from the spirit and scope of the invention. Accordingly, other embodiments are within the scope of the following claims.

What is claimed is:

1. An electrical connector. comprising:
a cup-like first housing having electrical contacts retained by a base portion; and
an adhesive filled capsule disposed in the first housing,

2. The electrical connector recited in claim 1 including a second housing configured for insertion into the cup-like first housing and having second electrical contacts retained by the second housing configured for mating with the first electrical contacts, such second housing having a member disposed for engaging and rupturing the capsule when the second housing is inserted within the first housing to release adhesive from the adhesive filled capsule into the cup-like, first housing.

3. An electrical connector, comprising:
a cup-like first dielectric housing having electrical contacts retained by a base portion, such electrical contacts being disposed in a region spaced from a sidewall portion;
an adhesive filled capsule disposed in the region; and
a second dielectric housing configured for insertion into the cup-like first dielectric housing and having second electrical contacts retained by the second housing configured for mating with the first electrical contacts, such second dielectric housing having a sidewall with a frontal portion disposed in the region for engaging and rupturing the capsule when the second dielectric housing is inserted within the first dielectric housing to release adhesive from the adhesive filled capsule into the cup-like, first dielectric housing.

4. An electrical connector, comprising:
(A) a first connector member comprising:
a cup-like first dielectric housing having a base portion and a sidewall portion, such sidewall portion terminating at the bottom portion;
a plurality of first electrical contacts retained by the base portion, the plurality of electrical contacts being disposed in a region spaced from the sidewall portion;
(B) a capsule disposed on the base portion in the region spaced from the sidewall portion;
(C) an adhesive disposed within the capsule;
(D) a second connector member comprising:
a second dielectric housing having a sidewall configured for insertion into the cup-like first dielectric housing, such sidewall having a frontal portion in registration with the region spaced from the sidewall portion of the first dielectric housing when the second dielectric housing is inserted within the first dielectric housing;
a plurality of second electrical contacts configured for mating with the first electrical contacts to provide electrical connection between the first electrical contacts and the second electrical contacts, such electrical contacts being retained by the second dielectric housing within the sidewall of the second dielectric housing; and
(E) wherein the frontal portion of the sidewall of the second dielectric housing engages and ruptures the capsule when the second dielectric housing is inserted within the first dielectric housing releasing the adhesive from the capsule into to the cup-like, first dielectric housing.

5. The electrical connector recited in claim 4 wherein the capsule is disposed on the sidewall and the base portion of the first dielectric member.

6. The electrical connector recited in claim 5 wherein the first electrical contacts are pins and the second electrical contacts are sleeves to receive the pins.

7. A method, comprising:
providing a cup-like first housing having electrical contacts retained by a base portion; and
disposing an adhesive filled capsule in the first housing.

8. The method of claim 7, further comprising:
inserting a second housing insertion into the cup-like first housing, such second electrical contacts being retained by the second housing and configured for mating with the first electrical contacts, such second housing having a member disposed for engaging and rupturing the capsule when the second housing is inserted within the first housing to release adhesive from the adhesive filled capsule into the cup-like, first housing.

9. The method of claim 7, further comprising:
engaging and rupturing the capsule with the member when the second housing is inserted within the first housing to release adhesive from the adhesive filled capsule into the cup-like, first housing.
